(19) United States
(12) Patent Application Publication
(10) Pub. No.: US 2014/0150099 A1
(43) Pub. Date: May 29, 2014

(54) METHOD AND DEVICE FOR DETECTING MALICIOUS CODE ON WEB PAGES

(71) Applicant: Tencent Technology (Shenzhen) Company Limited, Shenzhen, GD (CN)

(72) Inventors: Xiaohui Yuan, Shenzhen (CN); Hai Long, Shenzhen (CN); Shuai Li, Shenzhen (CN)

(21) Appl. No.: 14/130,233

(22) PCT Filed: Dec. 26, 2012
(86) PCT No.: PCT/CN2012/087530

§ 371 Date: Dec. 30, 2013

(30) Foreign Application Priority Data
Dec. 27, 2011 (CN) 201110445277.1

(51) Int. Cl. H04L 29/06

(52) U.S. Cl. CPC H04L 63/145
USPC 726/22

(57) ABSTRACT

A method for detecting malicious code on web pages includes: obtaining a function list by executing a specified code and a predefined object code; parsing the specified code and obtaining variable values according to a parsing result and the function list; and determining whether a malicious code exists on web pages according to variable values. A device for detecting malicious code on web pages is also provided.

### FIELD OF THE INVENTION

The present invention relates to the field of web page technology, and more particularly to method and device for detecting malicious code on web pages.

### BACKGROUND OF THE INVENTION

With the continuous development of information technology, people are getting used to gathering dynamic affair information by browsing web pages. As one of the important information-sharing technologies, web technology can provide users with a wealth of information.

However, due to lack of interactive features, poor reusability, and problems in maintenance of primitive static web pages, dynamic web technologies are gradually developed, and VBScript (Visual Basic Script) is one of them.

VBScript can be used to direct the client browser, dynamically implement HTML, and even combine the external program to web pages. However, due to lack of security, a malicious attacker may spread malicious code on web pages, download Trojan, attack user host and access user information via the flaws of VBScript technology.

Today, one of the means to detect malicious VBScript code is to convert the VBScript into JavaScript and then parse the JavaScript by using JavaScript scripting engine. However, there exists a flaw, i.e. the VBScript cannot be equivalently converted into the JavaScript and the converted JavaScript might have semantic functions deviated from those of the original VBScript. Accordingly inaccurate test results might be rendered.

### SUMMARY OF THE INVENTION

An embodiment of the present invention provides a method for detecting malicious code on web pages, which includes:

obtaining a function list by executing a specified code and a predefined object code;

parsing the specified code and obtaining variable values according to a parsing result and the function list; and

determining whether a malicious code exists on web pages according to variable values.

Another embodiment of the present invention provides a device for detecting malicious code on web pages, which includes:

a function-list-obtaining module configured to obtain a function list by executing a specified code and a predefined object code; and

a parsing and extracting module configured to parse the specified code and obtain variable values according to a parsing result and the function list, wherein a malicious code existing on web pages is determined according to the variable values.

The embodiments of present invention discloses method and device for detecting malicious code on web pages. Through sequentially obtaining the function list by executing VBScript code and predefined object code and obtaining variable values by parsing the VBScript code and a parsing result, the malicious script code on web pages can be detected in advance and consequently the associated system can block the malicious VBScript code and prompt a user if malicious VBScript code is detected; accordingly, the user's right is protected and the user can browser web pages with enhanced security.

### BRIEF DESCRIPTION OF THE DRAWINGS

FIG. 1 is a flowchart schematically illustrating a method for detecting malicious code on web pages in accordance with a preferred embodiment of the present invention;

FIG. 2 is a flowchart schematically illustrating a process of obtaining the function list by executing a specified code and a predefined object code in the method for detecting malicious code on web pages in accordance with the preferred embodiment of the present invention;

FIG. 3 is a flowchart schematically illustrating a process of parsing the specified code and thereby obtaining variable values according to the parsing results and the function list in the method for detecting malicious code on web pages in accordance with the preferred embodiment of the present invention;

FIG. 4 is a flowchart schematically illustrating a process of expanding the code according to the function list and the function procedure information in the method for detecting malicious code on web pages in accordance with the preferred embodiment of the present invention;

FIG. 5 is a schematic constructional diagram of a device for detecting malicious code on web pages in accordance with a preferred embodiment of the present invention;

FIG. 6 is a schematic constructional diagram of the function-list-obtaining module of the device for detecting malicious code on web pages in accordance with the preferred embodiment of the present invention;

FIG. 7 is a schematic constructional diagram of the parsing and extracting module of the device for detecting malicious code on web pages in accordance with the preferred embodiment of the present invention; and

FIG. 8 is a schematic constructional diagram of the expansion unit of the device for detecting malicious code on web pages in accordance with the preferred embodiment of the present invention.

### DETAILED DESCRIPTION OF PREFERRED EMBODIMENTS

For illustrating the objectives, technical means and advantages of the present invention in a clearer way, the present invention is described with reference to the drawings and embodiments. It is to be understood that the embodiments are used for illustrating the present invention rather than limiting the present invention.

The main solution provided in the embodiments of the invention is to obtain a function list by executing script code and predefined object code, parse the script code, extract variable values according to the parsing results and the function list, and verify the variable values. Thus, the web pages containing malicious script code can be detected in advance and thereby increasing the security for users to browser web pages.

The code referred in the present invention is script code, and specifically is VBScript code or other types of script code. Accordingly, the each following embodiment is described by using the VBScript code.

In a conventional method for detecting malicious VBScript code which might be contained in a web page, the VBScript is converted into JavaScript first and the JavaScript is then parsed. For solving a problem of relatively low conversion rate existing in the conventional method, an embodiment of the present invention uses an MSScript engine on the windows-based platform to detect malicious VBScript code. Specifically, the VBScript code is executed through the MSScript engine so that information such as variable and function information can be extracted from the VBScript code. The extracted information is then inputted into a feature extractor for extracting global variables from the VBScript code. Furthermore, an expansion procedure may be performed according to an embodiment of the present invention for extracting local variables, which might exist in function information and cannot be detected by processing the global variables.

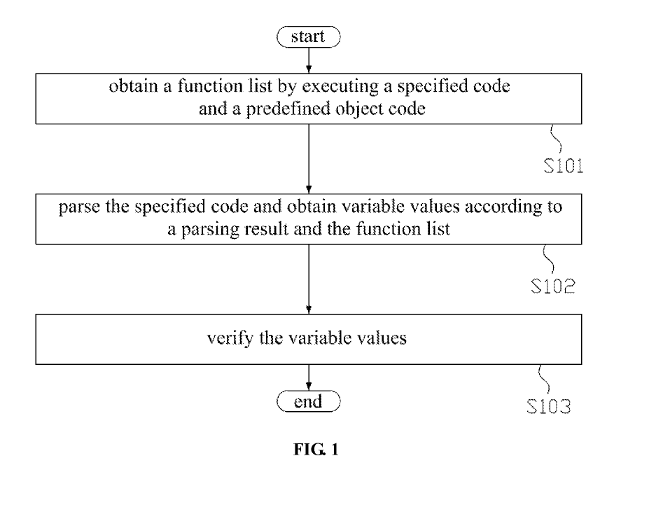

FIG. 1 summarizes a method for detecting malicious code on web pages according to a preferred embodiment of the present invention. The method includes the following steps.

In Step S101, a function list is obtained by executing a specified code and a predefined object code.

Herein VBScript code is taken as an example. First of all, commonly-used Browser and DOM objects, e.g. the Navigator object, Document object and Object object, are preferably predefined to avoid possible indefinite problem and execution failure encountered when the Browser and document object module (DOM) objects are directly inserted into the MSScript engine.

Then, the VBScript code and the predefined object code are executed by calling a code-executing method, e.g. the method ExecuteStatement, provided by the scripting interface IScriptControl.

After the codes is successfully executed, a procedure-name-list-obtaining method, e.g. the method GetProcedures, provided by the scripting interface IScriptControl is called to obtain the procedure (function) name list, and a variable-list-obtaining method, e.g. the method GetCodeObject, provided by the scripting interface IscriptControl is called to obtain an IDispatch interface pointer. Afterwards, the global variable list in the VBScript code is obtained by using the COM reflection mechanism, wherein the procedure name list and the global variable list are referred to as the resulting function list. Subsequently, Step 102 and Step 103 are performed to parse the VBScript code and obtain the variable values according to the parsing result and the function list, and verify the variable values.

In Step S102, the specified code is parsed so as to obtain variable values according to a parsing result and the function list.

In Step 103, the variable values are verified. Subsequently, whether a malicious code exists on web pages can be determined according to the verified variable values.

In steps S102, S103, detailed function procedure information such as a function parameter list and a function body, is obtained by parsing the original VBScript code after the function list is obtained, and then a new VBScript code is obtained by performing function procedure trimming on the original VBScript code so as to completely remove all function procedures from the original VBScript code. The purpose of performing the function procedure reduction on the original VBScript code is for executing the expanded VBScript code in the MSScript engine and thereby extracting the variable values contained therein.

Meanwhile, a local variable list is obtained by sequentially calling the method ExecuteStatement and the method GetCodeObject provided by the scripting interface IScriptControl for each function according to the detailed function procedure information in the resulting VBScript code. Since malicious execution code usually exists in the local variables, it is preferred to extracting and verifying the local variables in order to accurately determine whether there exists any malicious execution code or not. The local variables can be extracted and verified by way of the feature extractor.

Through the above process, all the basic information needed for the VBScript code expansion is obtained. In order to further improve the efficiency of the VBScript code expansion, an embodiment of the present embodiment introduces a function dependency table, through which a function can be expanded hierarchically and thereby improving the expansion efficiency.

Specifically, a two-dimensional dependency table indicating the dependency relationship among functions is generated by analyzing the call relationship for each function. Herein the dependency relationship is expressed by way of a reverse dependency, for example, as follows:

For functions A, B, C, D, E, F and G, there exists a function call relationship: functions B, D and G can be called by function A; functions C, E and G can be called by function B; and functions F and G can be called by function E.

Thus, a two-dimensional dependency table can be constructed as follows:

A→NIL;

B→A;

C→B;

D→A;

E→B;

F→E;

G→A, B, E.

For each function, the expansion process is mainly based on the function dependency table; accordingly, a function expansion selector is introduced in and designed for returning to next to-be-expanded function. Specifically, the function expansion selector is configured to traverse the current function list to obtain the first function not being expanded and having a function dependency relationship as NIL, which is returned to be next to-be-expanded function, and sequentially expand each to-be-expanded function in the function list.

For functions A, B, C, D, E, F and G described above, the expansion process is exemplarily illustrated as follows:

1. Expand function A if function A is not dependent on any other function;

2. Expand, after function A is expanded and accordingly the dependency relationships of functions B and D are NIL, either function B or function D subsequent to function A (the first scan to function B is selected in this example)

3. Expand, after function B is expanded and accordingly the dependency relationships of functions C, D and E are NIL, function C subsequent to function B;

4. Sequentially expand functions D and E subsequent to function C;

5. Sequentially expand, after function E is expanded and accordingly the dependency relationships of functions F and G are NIL, functions F and G.

For each function, the expansion is principally executed by finding the function to be called, constructing a new function body, and performing replacement. The construction of the new function body is performed by renaming function parameters and function local variables with function-name_variable-name (parameter-name)_call-ID. Furthermore, the parameters in the front part of the function body are local-variablized, and the evaluation corresponding to the parameters introduced during the calling is incorporated into the variables. The call ID value indicates a call number of the currently detected function, which is realized for preventing from variable conflict resulted from multiple calling and expansion of the function.

After the expansions of all the functions are completed, a new VBScript code is obtained.

The new VBScript code obtained after the completion of function expansion is inputted into and executed by the MSScript scripting engine. A list of all variable values is obtained according to a COM interface reflection mechanism, and the resulting variable values are then inputted into the feature extractor for the extraction and verification so as to complete the detection of the malicious VBScript code.

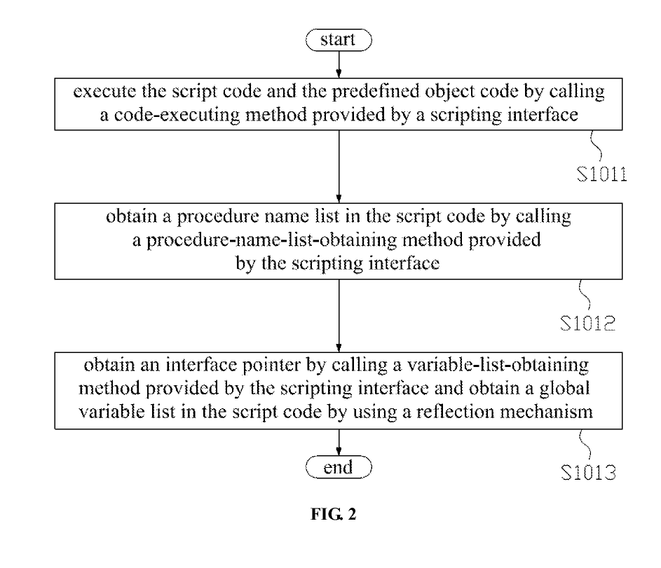

As illustrated in FIG. 2, in the aforementioned implementation process exemplified by the VBScript code, step S101 further includes:

Step S1011: execute the VBScript code and the predefined object code by calling the method ExecuteStatement provided by the scripting interface;

Step S1012: obtain the procedure name list in the VBScript code by calling the method GetProcedures provided by the scripting interface;

Step S1013: obtain the IDispatch interface pointer by calling the method GetCodeObject provided by the scripting interface and obtain the global variable list in the VBScript code by using the COM reflection mechanism.

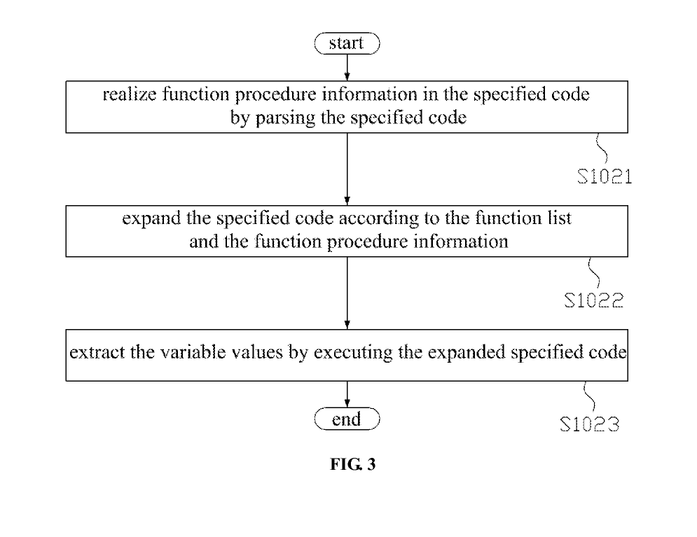

As illustrated in FIG. 3, step S102 includes:

Step S1021: obtain the function procedure information by parsing the specified code;

Step S1022: expand the specified code according to the function list and the function procedure information;

Step S1023: extract the variable values by executing the expanded specified code.

As illustrated in FIG. 4, step S1022 includes:

Step S10221: obtain the call relationship for each function according to the function procedure information;

Step S10222: generate the two-dimensional dependency table according to the call relationship for each function;

Step S10223: expand the VBScript code according to the function list and the two-dimensional dependency table.

By traversing the function list, the function expansion selector obtains the first function not being expanded and having a function dependency relationship as NIL, which is returned to be next to-be-expanded function, and sequentially expands each to-be-expanded function in the function list.

The present embodiment can successfully identify the web page containing malicious VBScript code on the windows-based platform, and consequently block the malicious VBScript code and prompt a user if malicious VBScript code is detected. Accordingly, the user's right to browse web pages with enhanced security can be assured of In addition, the present embodiment prevents from the errors, which might occur during the conversion from VBScript to JavaScript so as to detect malicious VBScript script code efficiently.

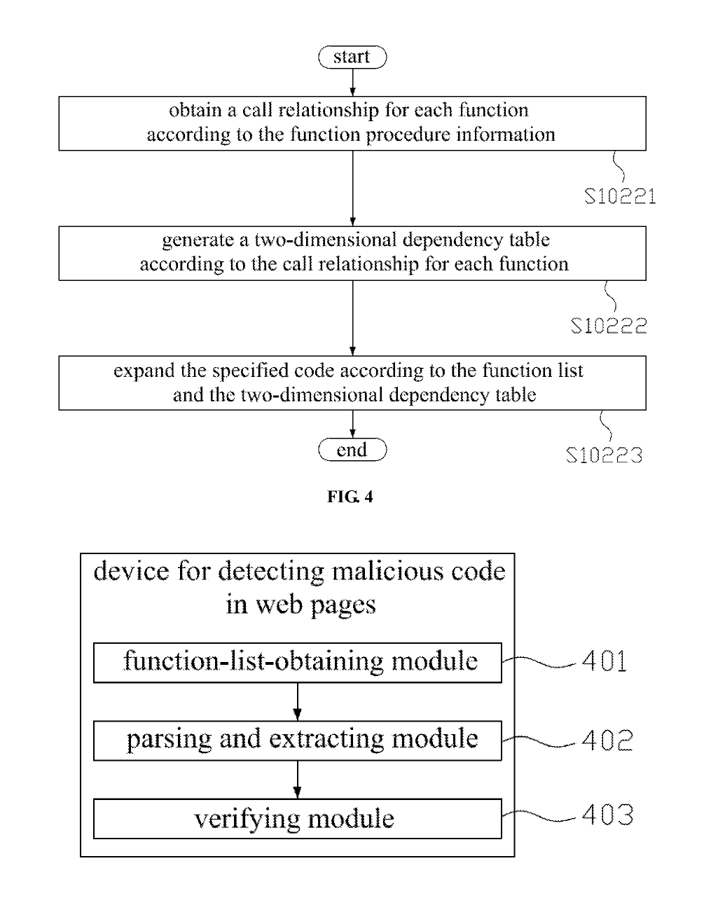

As illustrated in FIG. 5, a preferred embodiment of the present invention discloses a device for detecting malicious code on web pages, which includes a function-list-obtaining module 401, an parsing and extracting module 402 and a verifying module 403, wherein:

the function-list-obtaining module 401 is configured to obtain a function list by executing a specified code, e.g. VBSscript code, and a predefined object code;

the parsing and extracting module 402 is configured to parse the VBScript code and obtain variable values according to a parsing result and the function list; and

the verifying module 403 is configured to verify the variable values.

Herein VBScript code is taken as an example in the present embodiment. In view of the fact that the direct introduction of a Browser object and a document object module (DOM) object, which are commonly used in the VBScript code on web pages, into a MSScript engine would result in an indefinite object error, and consequently lead to failure in execution. Thus, by predefining these commonly-used Browser and DOM objects such as the Navigator object, Document object and Object object in the present embodiment, the problem resulting from the indefinite object error can be solved.

Then, the function-list-obtaining module 401 obtains the function list by calling the scripting interface to execute the VBScript code and the predefined object code. Specifically, the VBScript code and the predefined object code are executed by a code-executing method, e.g. the method ExecuteStatement, provided by the scripting interface IScriptControl.

After the code is successfully executed, the function-list-obtaining module 401 obtains the procedure (function) name list in the VBScript code by calling a procedure-name-list-obtaining method, e.g. the method GetProcedures, provided by the scripting interface IscriptControl, obtains the IDispatch interface pointer by calling a variable-list-obtaining method, e.g. the method GetCodeObject, provided by the scripting interface IscriptControl, and then obtains the global variable list in the VBScript code by using the COM reflection mechanism; wherein, the aforementioned procedure name list and the global variable list are referred to as the resulting function list.

After the function list is obtained, the parsing and extracting module 402 obtains the detailed function procedure information such as the function parameter list and the function body by parsing the original VBScript code, and obtains the new VBScript code by performing the function procedure trimming on the original VBScript code for completely removing all function procedures from the original VBScript code; wherein, the purpose of performing the function procedure trimming on the original VBScript code is for the execution of the expanded VBScript code in the MSScript engine and thereby extracting the variable values therein.

Meanwhile, the parsing and extracting module 402 obtains the local variable list by sequentially calling the methods ExecuteStatement and GetCodeObject provided by the scripting interface IScriptControl for each function according to the detailed function procedure information in the obtained VBScript code. Because the malicious execution code usually exists in the local variables, the existence of the malicious execution code can be determined by first obtaining the local variables and then executing the local variables in the feature extractor for verifying.

Through the above process, all the basic information needed for the expansion on the VBScript code is obtained; and the VBScript code is then expanded according to the function list and the function procedure information.

Additionally, in order to increase the VBScript code expansion efficiency, the present embodiment introduces a function dependency table, through which a function can be expanded hierarchically and thereby increasing the expansion efficiency.

Specifically, a two-dimensional dependency table indicating the dependency relationships between functions is generated by analyzing the call relationship for each function. Herein the dependency relationship is expressed by way of a reverse dependency, for example, as follows:

For functions A, B, C, D, E, F and G, there exists a function call relationship: functions B, D and G can be called by function A; functions C, E and G can be called by function B; and functions F and G can be called by function E.

Thus, a two-dimensional dependency table can be constructed as follows:

A→NIL;

B→A;

C→B;

D→A;

E→B;

F→E;

G→A, B, E.

For each function, the expansion process is mainly based on the function dependency table; accordingly, a function expansion selector is introduced in and designed for returning to the next to-be-expanded function. Specifically, the function expansion selector is configured to traverse the current function list to obtain the first function not being expanded and having a function dependency relationship as NIL, which is returned to be next to-be-expanded function, and sequentially expand each to-be-expanded function in the function list.

For the above example (functions A, B, C, D, E, F and G), the expansion process is illustrated as follows:

1. Expand function A if function A is not dependent on any other function;

2. Expand, after function A is expanded and accordingly the dependency relationships of functions B and D are NIL, either function B or function D subsequent to function A (the first scan to function B is selected in this example), after which the dependency relationship of functions C, D and E are NIL;

3. Expand, after function B is expanded and accordingly the dependency relationships of functions C, D and E are NIL, function C subsequent to function B;

4. Sequentially expand functions D and E subsequent to function C;

5. Sequentially expand, after function E is expanded and accordingly the dependency relationships of functions F and G are NIL, functions F and G.

For each function, the expansion is principally executed by finding the function to be called, constructing a new function body, and performing replacement. The construction of the new function body is performed by renaming function parameters and function local variables with function-name_variable-name (parameter-name)_call-ID. Furthermore, the parameters in the front part of the function body are local-variablized, and the evaluation corresponding to the parameters introduced during the calling is incorporated into the variables. The call ID value indicates a call number of the currently detected function, which is realized for preventing from variable conflict resulted from multiple calling and expansion of the function.

After the expansion of all the functions are completed, a new VBScript code is obtained.

The new VBScript code obtained after the completion of function expansion is inputted into and executed by the MSScript scripting engine. A list of all variable values is obtained according to a COM interface reflection mechanism, and the resulting variable values are then inputted into the feature extractor by the verifying module 403 for the extraction and verification so as to complete the detection of the malicious VBScript code.

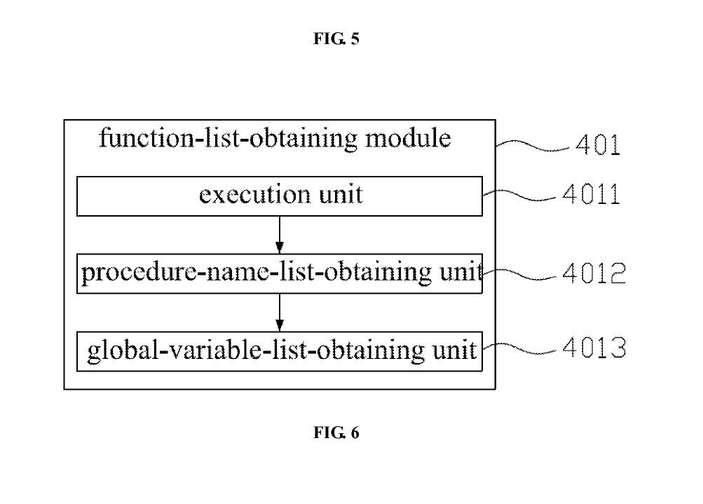

As illustrated in FIG. 6, in the specific implementation process exemplified by the VBScript code, the function-list-obtaining module 401 includes: an execution unit 4011, a procedure-name-list-obtaining unit 4012 and a global-variable-list-obtaining unit 4013, wherein:

the execution unit 4011 is configured to execute the VBScript code and the predefined object code by calling the method ExecuteStatement provided by the scripting interface;

the procedure-name-list-obtaining unit 4012 is configured to obtain the procedure name list in the VBScript code by calling the method GetProcedures provided by the scripting interface;

the global-variable-list-obtaining unit 4013 is configured to obtain the IDispatch interface pointer by calling the method GetCodeObject provided by the scripting interface and obtain the global variable list in the VBScript code by using the COM reflection mechanism.

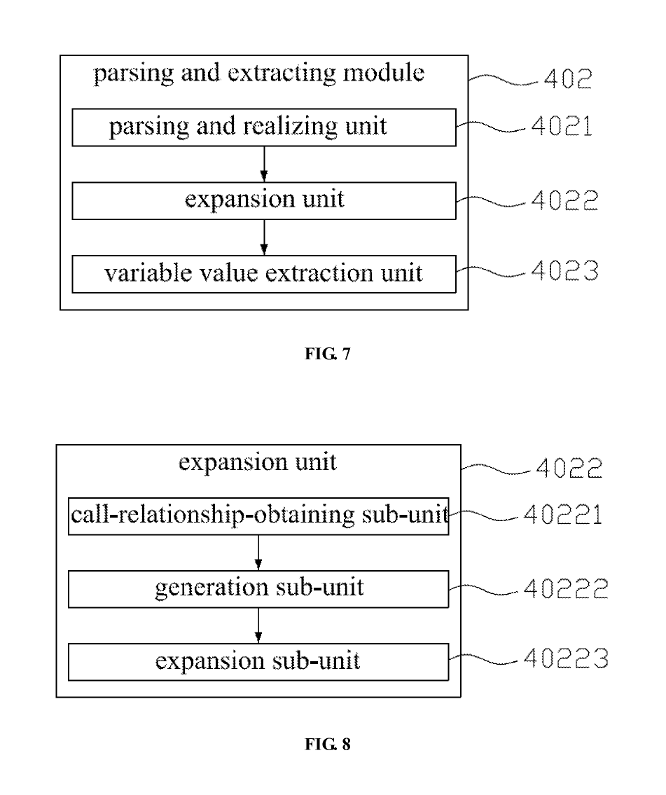

As illustrated in FIG. 7, the parsing and extracting module 402 includes:

a parsing and realizing unit 4021 configured to parse the specified code and realize the function procedure information in the specified code;

an expansion unit 4022 configured to expand the specified code according to the function list and the function procedure information;

a variable value extraction unit 4023 configured to extract the variable values by executing the expanded specified code.

As illustrated in FIG. 8, the expansion unit 4022 includes: a call-relationship-obtaining sub-unit 40221, a generation sub-unit 40222 and an expansion sub-unit 40223, wherein:

the call-relationship-obtaining sub-unit 40221 is configured to obtain the call relationship for each function according to the function procedure information;

the generation sub-unit 40222 is configured to generate the two-dimensional dependency table according to the call relationship for each function;

the expansion sub-unit 40223 is configured to expand the VBScript code according to the function list and the two-dimensional dependency table.

Specifically, the expansion sub-unit 40223 traverses the function list to obtain the first function not being expanded and having a function dependency relationship as NIL, which is returned to be next to-be-expanded function, and sequentially expands each to-be-expanded function in the function list.

In summary, the present invention discloses method and device for detecting malicious code on web pages. Through sequentially obtaining the function list by executing VBScript code and predefined object code through the script interface, obtaining the function procedure information in the VBScript code by parsing the VBScript code, expanding the VBScript code according to the function list and the function procedure information and extracting variable values by running the expanded VBScript code in the MSScript engine and for verifying, the malicious script code on web pages can be detected in advance and consequently the associated system can block the malicious VBScript code and prompt a user if malicious VBScript code is detected; accordingly, the user's right is protected and the user can browser web pages with enhanced security.

What is described above is preferred embodiments according to the present invention only rather than used for limiting the present invention. On the contrary, it is intended to cover various modifications and similar arrangements included within the spirit and scope of the appended claims which are to be accorded with the broadest interpretation so as to encompass all such modifications and similar structures.

1. A method for detecting malicious code on web pages, comprising steps of:
obtaining a function list by executing a specified code and a predefined object code;
parsing the specified code and obtaining variable values according to a parsing result and the function list; and
determining whether a malicious code exists on web pages according to variable values;
wherein the step of parsing the specified code and obtaining variable values according to the parsing result and the function list comprises steps of:
realizing a function procedure information in the specified code by parsing the specified code;
expanding the specified code according to the function list and the function procedure information; and
extracting the variable values by executing the expanded specified code.

2. (canceled)

3. The method according to claim 1, further comprising:
verifying the variable values.

4. The method according to claim 1, wherein the specified code is a script code and the step of obtaining a function list by executing a specified code and a predefined object code comprises steps of:
executing the script code and the predefined object code by calling a code-executing method provided by a scripting interface;
obtaining a procedure name list in the script code by calling a procedure-name-list-obtaining method provided by the scripting interface; and
obtaining an interface pointer by calling a variable-list-obtaining method provided by the scripting interface and obtaining a global variable list in the script code by using a reflection mechanism.

5. The method according to claim 1, wherein the step of expanding the specified code according to the function list and the function procedure information comprises steps of:
obtaining a call relationship for each function according to the function procedure information;
generating a two-dimensional dependency table according to the call relationship for each function; and
expanding the specified code according to the function list and the two-dimensional dependency table.

6. The method according to claim 5, wherein the step of expanding the specified code according to the function list and the two-dimensional dependency table comprises steps of:
traversing the function list to obtain the first function not being expanded and having a function dependency relationship as NIL, which is returned to be next to-be-expanded function; and
sequentially expanding each to-be-expanded function in the function list.

7. The method according to claims 4, wherein the step of realizing a function procedure information in the specified code by parsing the specified code comprises a step of:
obtaining a local variable list by sequentially calling the code-executing method and the variable-list-obtaining method for each function.

8. A device for detecting malicious code on web pages, comprising:
a function-list-obtaining module configured to obtain a function list by executing a specified code and a predefined object code; and
a parsing and extracting module configured to parse the specified code and obtain variable values according to a parsing result and the function list,
wherein a malicious code existing on web pages is determined according to the variable values;
wherein the parsing and extracting module comprises:
a parsing and realizing unit configured to parse the specified code and realize a function procedure information in the specified code;
an expansion unit configured to expand the specified code according to the function list and the function procedure information; and
a variable value extraction unit configured to extract the variable values by executing the expanded specified code.

9. (canceled)

10. The device according to claim 8, further comprising:
a verifying module configured to verify the variable values.

11. The device according to claim 8, wherein the specified code is a script code, and the function-list-obtaining module comprises:
an execution unit configured to execute the script code and the predefined object code by calling a code-executing method provided by a scripting interface;
a procedure-name-list-obtaining unit configured to obtain a procedure name list in the script code by calling a procedure-name-list-obtaining method provided by the scripting interface; and
a global-variable-list-obtaining unit configured to obtain an interface pointer by calling a variable-list-obtaining method provided by the scripting interface and obtain a global variable list in the script code by using a reflection mechanism.

12. The device according to claim 8, wherein the expansion unit comprises:
a call-relationship-obtaining sub-unit configured to obtain the call relationship for each function according to the function procedure information;
a generation sub-unit configured to generate a two-dimensional dependency table according to the call relationship for each function; and
an expansion sub-unit configured to expand the specified code according to the function list and the two-dimensional dependency table.

13. The device according to claim 12, wherein the expansion sub-unit is further configured to traverse the function list to obtain the first function not being expanded and having a function dependency relationship as NIL, which is returned to be next to-be-expanded function, and sequentially expand each to-be-expanded function in the function list.

14. The device according to claim 11, wherein the parsing and extracting module is further configured to obtain a local variable list by sequentially calling the code-executing method and the variable-list-obtaining method for each function.
